(19) United States
(12) Patent Application Publication
(10) Pub. No.: US 2007/0018948 A1
(43) Pub. Date: Jan. 25, 2007

(54) Apparatus for stabilizing an electronic device during data input and device control

(76) Inventors: Elaine Chen, Arlington, MA (US); Paul Dilascia, Watertown, MA (US); Beth Marcus, Bedford, MA (US)

Correspondence Address: FISH & RICHARDSON, PC, P.O. BOX 1022, MINNEAPOLIS, MN, 55440-1022, US

(21) Appl. No.: 11/187,588

(22) Filed: Jul. 22, 2005

(51) Int. Cl. G09G 5/00

(52) U.S. Cl. 345/156

(57) ABSTRACT

A stabilizer for a hand-held electronic device during use of the device may include a grip configured to be held by a human hand and a connection mechanism to couple the grip to the hand-held electronic device. The stabilizer may also include a locking mechanism coupled to the connection mechanism. The locking mechanism may be operable to lock the extension arm in place. The stabilizer may be configured to be in an ergonomic position so that a user's thumb or one or more fingers is not required to hold the device, but instead is biomechanically or kinematically suited to freely access a plurality of input elements on one or more surfaces of the hand-held electronic device.

### BACKGROUND

The following description relates to apparatus for stabilizing electronic devices, particularly hand-held electronic devices, such as cell phones, personal digital assistants (“PDAs”), pocket personal computers, smart phones, hand-held game devices, bar-code readers, remote controls, and other similar input devices having a keypad or one or more input elements, during data input and device control.

Conventional electronic devices, such as cell phones, personal digital assistants (“PDAs”), pocket personal computers, smart phones, hand-held game devices, bar-code readers, remote controls, and other similar input devices having a keypad or one or more input elements, have become increasingly sophisticated and physically smaller due in part to a decrease in the price of processing power and a concurrent increase in demand by consumers for smaller devices. Such devices, however, tend to be limited in function and utility by the user's ability to comfortably interface with the device for data input (e.g., text, numeric, and functional input) and/or device control (e.g., game control during game play), which becomes increasingly more difficult and more uncomfortable to do as the available space on the device's surface for positioning the input elements, which are used for data input and/or device control, continues to decrease.

For data input, in most conventional hand-held electronic devices, a user typically inputs data through miniature keyboards and keypads used in combination with chordal input techniques, modal input techniques and/or smart keys, or through touch screens used in combination with on-screen keyboard or keypad software or hand-writing recognition software. The number of input elements making up a miniature keyboard or keypad varies, but typically a keypad used on most conventional hand-held electronic devices includes twelve input elements. Most often these input elements are placed on the bottom half or bottom third of the front face of the device. With such electronic devices, a user may input data using his thumbs while grasping the device with both hands, or may input data using his thumb while grasping the device with the same hand, or may input data using his fingers while holding the device in his other hand.

Any of these methods of inputting data (particularly thumb input) in conventional hand-held electronic devices can result in repetitive strain injuries (RSI) especially for those users who tend to spend a lot of time inputting data in smaller hand-held electronic devices, such as cell phones, PDAs, and Blackberry's. Moreover, particularly for thumb input, due to the physically small size of most hand-held electronic devices and the location of the input elements on the front face of such electronic devices, often times the user's thumb is required to hold the device while trying to reach the input elements located at the bottom of the front face of such devices, e.g., the input element representing the space key or input elements representing the letters p through y on a keypad or the bottom row of input elements formed to represent a QWERTY keyboard. This requires the user's thumb to apply substantial force in an awkward position.

For game control, in most hand-held electronic devices, a user typically controls game play through the use of some form of input element, such as on a miniature keypad and/or directional pad (“D-pad”), which typically is located on the front surface of the device. Game control on some hand-held electronic devices, such as cell phones, is inherently one handed or at most two thumbed because of the size of the device, while game control on other hand-held electronic devices, such as PDAs and conventional game console controllers, is typically two-handed. Similar to inputting data on these hand-held electronic devices, game control typically results in repetitive stress injuries especially for those users who are avid game players.

### SUMMARY

The present inventors recognized that conventional hand-held electronic devices because of their small size tended to be relatively cumbersome, inefficient and uncomfortable to use because, among other reasons, they were not designed to take advantage of the physical size ranges and biomechanics of the human hand. For example, the present inventors recognized that for users who hold such electronic devices with one hand, the user's thumb is often used to depress the input elements located on the front face of such devices, and to depress those input elements located near the bottom of the front face, the user's thumb is often required to hold the device while pressing those input elements, which results in the user's thumb having to apply a great deal of force in an awkward position. In addition, there are often input elements on the sides of the device. The present inventors recognized that, if a user stabilizes the device with one or more fingers near these input elements, then the user will have a lot of difficulty to both depress these input elements and keep the device stable at the same time. Instead, the user may have to use his other hand to hold the device in order to reach these input elements. The present inventors further recognized that by separating the function of holding a hand-held electronic device from actuating the input elements, the thumb is better able to reach the input elements while not having to assume such awkward positions.

Consequently, the present inventors developed an apparatus (e.g., a stabilizer) for a hand-held electronic device that allows a user to stabilize the phone so that his thumb(s) and/or finger(s) can comfortably reach and press the input elements (e.g., keys) of a keypad or miniature keyboard positioned on most conventional electronic hand-held electronic devices for data input and device control without having the device fall out of the user's hand or having a portion of the user's hand obscuring access to the input elements.

Implementations of the stabilizing apparatus for hand-held electronic devices (either one handed or two handed) and a hand-held electronic device including a stabilizing apparatus described here may include various combinations of the following features.

In one implementation, an apparatus for stabilizing a hand-held electronic device during use of the device includes a grip configured to be held by a human hand and a connection mechanism to couple the grip to the hand-held electronic device. The connection mechanism may include, e.g., an extension arm, one or more clamps or a strap. The extension arm may retract or extend in length and may rotate about a pivot. The extension arm may be an articulated member, which includes a plurality of independently moving segments. The grip attached to such an extension arm may then be positioned so that the user's thumb or one or more fingers are not needed to stabilize the electronic device during use, but instead may be used to freely reach in a kinematically or biomechanical proper manner a plurality of input elements disposed on one or more surfaces of the electronic device. In another implementation, an attachment for providing stability and comfort during data input or control of a hand-held electronic device includes a grip configured to be held by a human hand, an extension arm having a first end coupled to the grip and a second end coupled to the hand-held electronic device, and a locking mechanism coupled to the extension arm. The locking mechanism may be operable to lock the extension arm in place. In yet another implementation, a hand-held electronic device includes a first shell having a plurality of input elements disposed on one or more surfaces, and a stabilizer configured for a human hand and coupled to the first shell, the stabilizer being operable be in an ergonomic position so that a thumb or a finger of the human hand is kinematically suited to access a plurality of input elements on one or more surfaces of the hand-held electronic device.

The stabilizing apparatus described here may provide one or more of the following advantages. It allows a user to ergonomically hold and stabilize a hand-held electronic device, such as a cell phone, so that the user's thumb or fingers can comfortably operate any input element on any surface of the device, especially for data input operations (e.g., text messaging and e-mail), navigation operations (e.g., mobile web browsing or on-line shopping via mobile portals) and game control, without having the phone fall out of the user's hand(s), or having a portion of the user's hand(s) obscure access to the input elements, or having to apply high levels of force in awkward positions that combined with the repetitions inherent in data input on hand held electronic devices can lead to repetitive strain injuries (RSI).

For most users, data input typically is faster with use of the stabilizing apparatus described here because it separates the function of holding the hand-held electronic device from pressing the input elements. This separation makes it much more biomechanically efficient for the hand to access and operate all the input elements on any surface of the device. For those users who prefer thumb input, the stabilizing apparatus allows them to use their thumb(s) during data input or device control in a more ergonomic and biomechanically optimized manner so as to reduce stress on the thumb. In particular, the thumb is not needed to stabilize the hand-held electronic device, such as a cell phone, during data input to balance the reaction forces created by input element press. For those users who prefer finger input, the stabilizing apparatus allows them to hold the electronic device in one hand without having that hand get in the way and obscuring access to the input elements by the fingers of the other hand during data input or device control.

These advantages may be achieved without having to, e.g., increase the size of the keypad or miniature keyboard or size of the hand-held electronic device to achieve similar results, i.e., use of the stabilizing apparatus with a hand-held electronic device typically will make the hand-held electronic device as comfortable and ergonomic to use as a far bigger device but without creating a larger physical footprint.

Details of one or more implementations are set forth in the accompanying drawings and the description below. Other features and advantages will be apparent from the description and drawings, and from the claims.

### DESCRIPTION OF DRAWINGS

FIG. 1 depicts a stabilizing apparatus integrated with a hand-held electronic device.

FIGS. 2a-e depict a stabilizing apparatus integrated with and completely contained within the contours of a hand-held electronic device, wherein the stabilizing apparatus may slide along the long axis of and extend out from electronic device.

FIGS. 3a-c depict a stabilizing apparatus integrated with, but extends beyond the contours of a hand-held electronic device, wherein the stabilizing apparatus may slide along the long axis of and extend out from the electronic device.

FIG. 4 depicts a lateral moving stabilizing apparatus integrated with and completely contained within the contours of a hand-held electronic device.

FIG. 5 depicts a rotatable stabilizing apparatus attached to a hand-held electronic device.

FIG. 6 depicts a attachable and detachable stabilizing apparatus for a conventional hand-held electronic device.

FIG. 7 depicts a stabilizing apparatus integrated with a two-handed hand-held electronic device.

FIGS. 8a-b depict a stabilizing apparatus integrated with the contours of a two-handed hand-held electronic device, wherein the stabilizing apparatus may slide along the lateral axis of and extend out from electronic device.

Like reference symbols in the various drawings indicate like elements.

### DETAILED DESCRIPTION

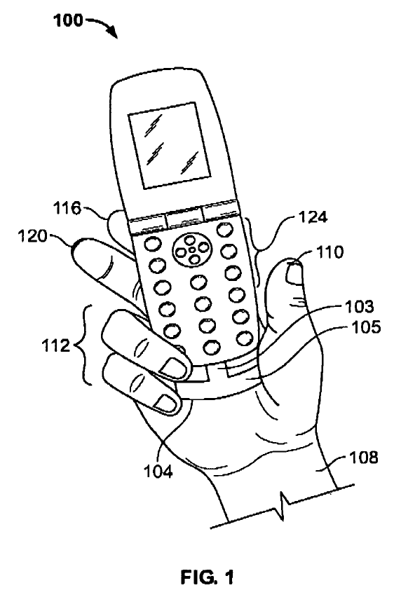

FIG. 1 depicts a stabilizing apparatus 104 integrated with a hand-held electronic device 100, such as a cell phone. The stabilizing apparatus 104 includes an extension arm 103 and a grip 105. The extension arm 103 is attached to the grip 105 to form a T-shaped stabilizing apparatus. The width of the grip 105 is approximately the width of the electronic device 100 and may have rounded corners and/or textured surfaces for resting comfortably in the palm of a user's hand 108. Alternatively, the grip 105 may be a detachable item, which can be modified by a user or customized to reflect fashion or hand size variations (e.g., sports icons or cartoon characters, left and right handed, or small or large handed)

The length of the extension arm 103 is of suitable length to allow the stabilizing apparatus 104 to extend out along the long axis of the electronic device 100 to fit comfortably in a user's hand 108. As shown, the electronic device 100 with the stabilizing apparatus 104 extended rests in a user's hand 108. With the stabilizing apparatus 104 extended sufficiently from the electronic device 100, the user is allowed to stabilize the electronic device 100 by, e.g., resting the stabilizing apparatus 104 in the palm of the user's hand 108, with one end of the stabilizing apparatus 104 pressed against the base of the user's thumb 110 and another end pressed against the user's pinky and/or ring finger(s) 112, or, for larger hands, with one end of the stabilizing apparatus 104 braced between the user's thumb side of the palm and another end pressed against the user's pinky side of the palm). As a result, the user's thumb 110, index finger 116 and middle finger 120 are freed to reach and operate comfortably any of the input elements 124 on any surface of the electronic device 100 in a correct kinematic and biomechanical manner.

The stabilizing apparatus 104 may be fully adjustable along the length of the extension arm 103. Also the shape of the grip 105 and angle of extension may be fully adjustable. With the stabilizing apparatus 104 being fully adjustable to extend out along the long axis of the electronic device 100, the user is permitted to ergonomically hold the electronic device in the palm of his hand and use his index finger and thumb in opposition to operate any input elements that may be located on the back or sides of the hand-held device (e.g., index or shift input elements—not shown) and input elements 124 on the front of the device 100 (e.g., key pad buttons or other buttons or controls). Use of the stabilizing apparatus 104, particularly with modern conventional cell phones, mimics the level of comfort offered by larger hand-held cell phones or regular cordless telephones without changing the physical footprint of modern looking, physically smaller cell phones.

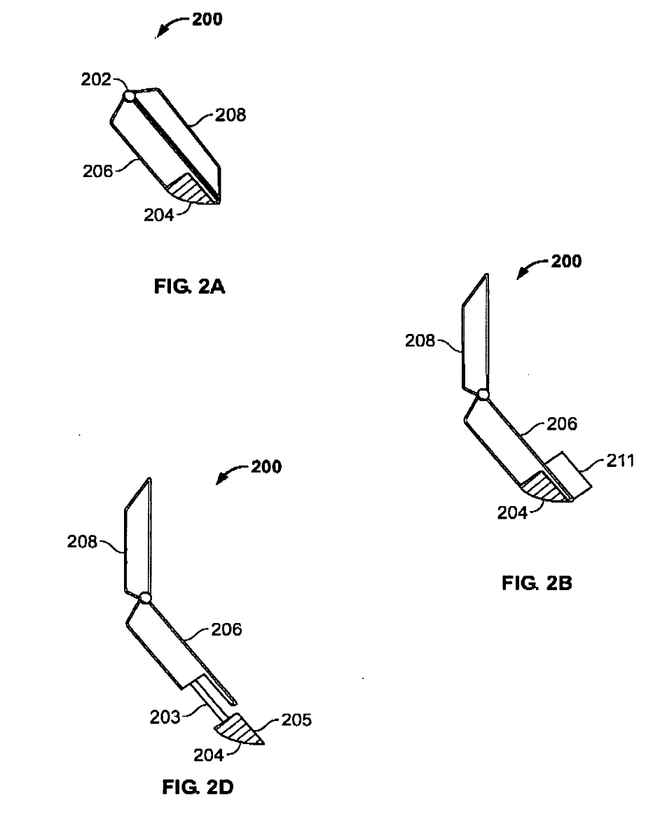

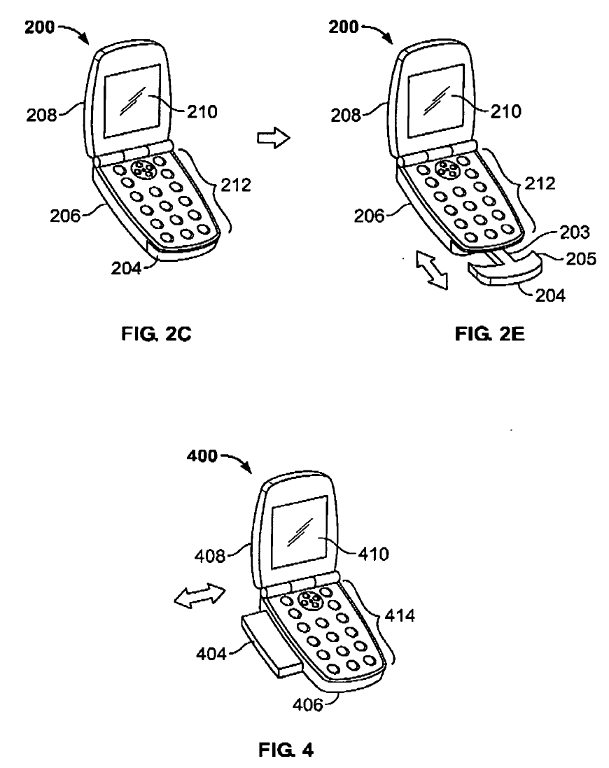

FIGS. 2a-e depict a stabilizing apparatus 204 integrated with and completely contained within the contours of a conventional hand-held electronic device 200 (e.g., a clam-shell cell phone or flip-phone), wherein the stabilizing apparatus may slide along the long axis of and extend out from the device 200. FIG. 2a depicts a side-view of the electronic device 200 folded with shell 208 folded on top of shell 206, which is permitted by hinge 202. The shell 206 has disposed on a front surface input elements, such as buttons of a keypad or miniature keyboard (not shown). The shell 208 has disposed on a front surface a display, such as a LCD screen. The stabilizing apparatus 204 is recessed within the shell 206.

FIG. 2b depicts a side-view of the electronic device 200 flipped open, with the stabilizing apparatus 204 recessed fully within shell 206. The thickness of the stabilizing apparatus 204 is less than the thickness of the shell 206 so that the stabilizing apparatus 204 may be recessed or retracted into the shell 206 completely and reside below a portion 211 of a front surface of the shell 206. FIG. 2c depicts a front-view of the electronic device 200 flipped open, with the stabilizing apparatus recessed fully within shell 206 and a display 210 disposed on a front surface of the shell 208, and input elements 212 disposed on the front surface of the shell 206.

FIG. 2d depicts a side-view of the electronic device 200 with the stabilizing apparatus 204 in an extended state, where the stabilizing apparatus is extended away from the shell 206. The stabilizing apparatus 204 includes an extension arm 203 and a grip 205. The width of the grip 205 is approximately the width of the electronic device 204 and may have rounded corners and/or textured surfaces for resting comfortably in the palm of a user's hand. As noted above, the grip 205 may be any shape and the grip 205 may be detachable and interchangeable. The length of the extension arm 203 is of suitable length too allow the stabilizing apparatus 204 to completely collapse into the shell 206 when fully retracted.

FIG. 2e depicts a front-view of the electronic device 200 with the stabilizing apparatus 204 in an extended state. The width of the grip 205 is approximately the width of the electronic device 204 and may have rounded corners and/or textured surfaces for resting comfortably in the palm of a user's hand. The distance the stabilizing apparatus 204 extends from shell 206 may be adjusted and optimized to a particular user's hand. Moreover, the extension of the stabilizing apparatus 204 may be done through manual means, e.g., by the user using his hand to extend the stabilizing apparatus to a comfortable distance, or through automatic means, e.g., by pressing a predetermined input element such as one of the input elements 212 which engages or actuates a spring or an electric motor that extends the stabilizing apparatus to a predetermined distance out from the shell 206.

The stabilizing apparatus 204 as implemented and depicted in FIGS. 2a-e results in numerous advantages as noted above. For example, it allows a user to ergonomically hold and stabilize the hand-held electronic device 200 so that the user's thumb or fingers can comfortably operate any input elements on any surface on the device without having the phone fall out of the user's hand(s) or the having a portion of the user's hand(s) obscure access to the input elements or without having to exert undue force or put the fingers or hand into awkward configurations. Moreover, for those users who prefer thumb input, the thumb, index finger and third finger are not needed to stabilize the electronic device 200 during data input to balance the reaction forces created by input element press. These advantages may be achieved without increasing the size of the electronic device 200 compared to conventional hand-held electronic devices, such as cell phones and PDAs. Thus, use of the stabilizing apparatus 204 integrated fully within the electronic device 200 will feel like the hand-held electronic device is physically larger but without having a larger physical footprint when the stabilizing apparatus 204 is fully retracted.

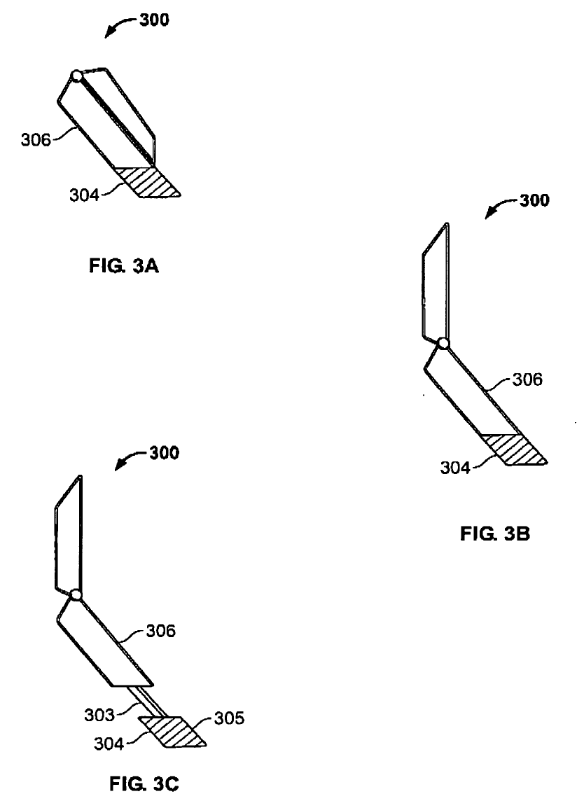

FIGS. 3a-c depict a side-view of a stabilizing apparatus 304 integrated with, but extends beyond the contours of a hand-held electronic device 300 in a fully recessed state, wherein the stabilizing apparatus may slide along the long axis of and extend out from the electronic device. The stabilizing apparatus 304 includes an extension arm 303 and a grip 305. The width of the grip 305 is approximately the width of the electronic device 304 and may have rounded corners and/or textured surfaces for resting comfortably in the palm of a user's hand. The length of the extension arm 303 is of suitable length so that grip 305 is flush with the shell 306 when the stabilizing apparatus 304 is fully retracted. This implementation of the stabilizing apparatus has the added advantage of enabling additional functionality to be incorporated into the stabilizer such as enhanced antenna capabilities or other features.

FIGS. 3a-c are similar to FIGS. 2a, b and d, except the stabilizing apparatus 304 extends beyond the main body of the shell 306 and the thickness of the stabilizing apparatus 304 is approximately the thickness of the shell 306. Alternatively, the thickness of the stabilizing apparatus 304 may be smaller or larger than the thickness of the shell 306.

FIG. 4 depicts a lateral moving stabilizing apparatus 404 integrated with and completely contained within the contours of a hand-held electronic device 400 (e.g., a claim-shell cell phone or flip-phone), wherein the stabilizing apparatus may slide along the lateral axis of and extend out from the electronic device 400. In this implementation, the stabilizing apparatus is integrated with shell 406, which contains a plurality of input elements 412 that may comprise a keypad or miniature keyboard on a front surface. The shell 408 contains a display 410, such as a LCD. As shown, the stabilizing apparatus 404 may slide laterally to the left, which may be suitable for users whose dominant hand is their right hand or who prefer to input data or control the device with their right hand. In that case, with the stabilizing apparatus 404 extended out to the left, a user may hold the stabilizing apparatus like a handle with his non-dominant hand (e.g., the left hand) while the input elements 412 may be reached and operated with the dominant hand (e.g., the right hand). Alternatively, the stabilizing apparatus 404 may slide laterally to the right, which may be suitable for users who prefer to hold the electronic device 400 with their right hand and reach and operate the input elements 412 with their left hand (or vice versa as some users may hold the device in a counter intuitive manner).

FIG. 5 depicts a rotatable stabilizing apparatus 504 attached to a hand-held electronic device 500 (e.g., a claim-shell cell phone or flip-phone) through pivot 520, which is disposed on the back-side of the shell 506 of electronic device 500, which may be used to achieve the ergonomic and biomechanical benefits as noted above. The pivot axis is perpendicular to front surface of the shell 506. The stabilizing apparatus 504 is be pie-shaped or crescent shaped. Alternatively, the stabilizing apparatus 504 may be an adjustable shape or any other shape which permits a user to place the stabilizing apparatus 504 in the user's hand so that it is comfortable during data input and device control, e.g., between the base of the user's thumb and the user's pinky and ring fingers. When a user desires to perform data input functions or play a game, the user may rotate the stabilizing apparatus 504 clockwise or counterclockwise from the recessed or fully retracted state 526 of the stabilizing apparatus 504 away from the body of shell 506 to the extended state 528 of the stabilizing apparatus 504. As a result, the user's thumb is not needed to stabilize or hold the phone. Instead, the user's thumb may be used to reach and operate the input elements (not shown) of the electronic device 500.

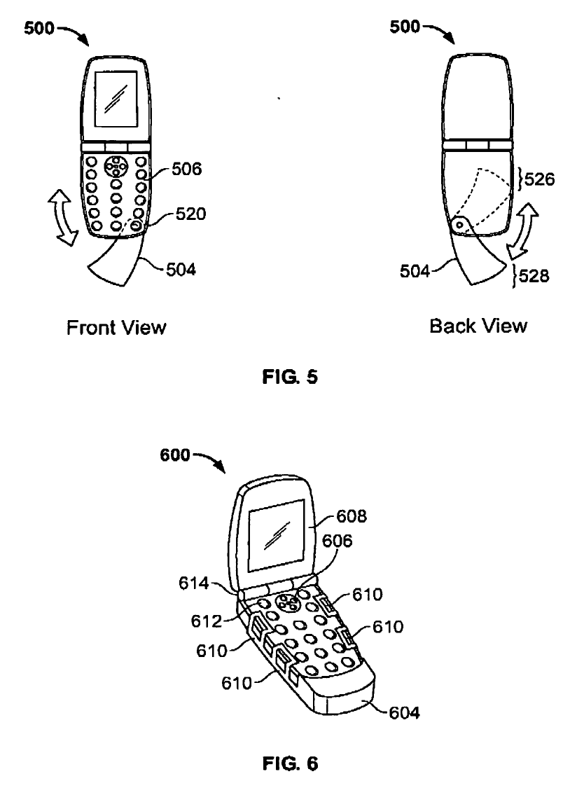

FIG. 6 depicts a stabilizing apparatus 604 that may be attached to a conventional hand-held electronic device 600 (e.g., a claim-shell cell phone or flip-phone). The stabilizing apparatus 604 includes clamps 610 integrated with a grip 605. The stabilizing apparatus 604 may be attached to or detached from a shell 606, which may contain a plurality of input elements 612. For example, the stabilizing apparatus 604 can be slid on or snapped on the shell 606. A shell 608 contains a display, such as an LCD screen. The shell 608 is connected to shell 606 by pivot 614. The stabilizing apparatus 604 may be used as a handle during use of the electronic device 600 such as during voice conversations, data heavy tasks (e.g., e-mail and text messaging), and gaming.

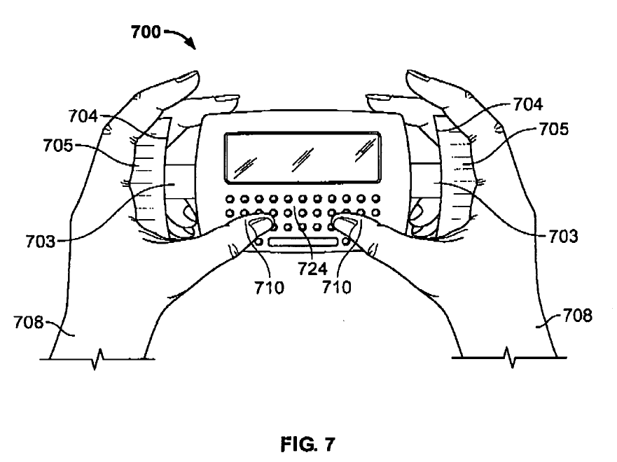

FIG. 7 depicts a stabilizing apparatus 704 integrated with a two-handed hand-held electronic device 700, such as a PDA or Blackberry. The stabilizing apparatus 704 includes an extension arm 703 and a grip 705. The extension is arm 703 attached to the grip 705 to form a T-shaped stabilizing apparatus. The width of the grip 705 is approximately the length of the electronic device 700 and may have rounded corners and/or textured surfaces for resting comfortably in the palm of a user's hands 708. Alternatively, the grip 705 may be a detachable item, which can be modified by a user or customized to reflect fashion or hand size variations (e.g., sports icons or cartoon characters, left and right handed, or small or large handed)

The length of the extension arm 703 is of suitable length to allow the stabilizing apparatus 704 to extend out along the lateral axis of the electronic device 700 to fit comfortably in a user's hands 708. As shown, the electronic device 700 with the stabilizing apparatus 704 extended rests in a user's hands 708. With the stabilizing apparatus 704 extended sufficiently from the electronic device 700, the user is allowed to stabilize the electronic device 700 with his fingers. As a result, the user's thumbs 710 are freed to reach and operate comfortably any of the input elements 724 in a correct kinematic and biomechanical manner.

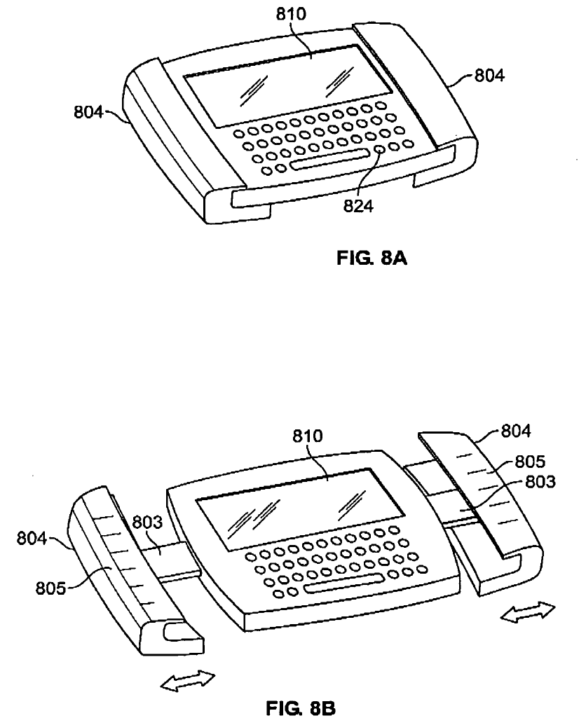

FIGS. 8a-b depict a stabilizing apparatus 804 integrated with the contours of a two-handed hand-held electronic device 800, wherein the stabilizing apparatus may slide along the lateral axis of and extend out from the electronic device 800. FIG. 8a depicts a front-view of the electronic device 800 with the stabilizing apparatus 804 retracted and a display 810 and input elements 824 disposed on a front surface of the electronic device 800. FIG. 8b depicts a front-view of the electronic device 800 with the stabilizing apparatus 804 extended. The stabilizing apparatus 804 includes an extension arm 803 and a grip 805, which wraps around the contours of the electronic device 800, such that the width of the electronic device 800 integrated with the stabilizing apparatus 800 is not significantly increased. The length of the grip 805 is approximately the length of the electronic device 304 and may have rounded corners and/or textured surfaces for resting comfortably in the palm of a user's hand. The distance the stabilizing apparatus 804 extends from the device 800 may be adjusted and optimized to a particular user's hand. Moreover, the extension of the stabilizing apparatus 804 may be done through manual means or through automatic means.

A number of implementations have been described. The stabilizing apparatus described in these implementations may be made of various materials, such as injection molded plastic, rubber or other machined, molded or cast materials and may be either stiff or compliant. Other implementations may include different or additional features. For example, the stabilizing apparatus may spring out or be manually released or latched. Furthermore, the stabilizing apparatus may include a pressure or force-sensitive sensor array disposed on one or more surfaces of the stabilizing apparatus, and may be stowed completely into a hand-held electronic device for storage and protection when not in use but slides out to be used both as a handle and as a surface for additional input elements. Also, the stabilizing apparatus may serve as the battery, the antenna, or other operable component of the hand-held electronic device itself. Additionally, the grip of the stabilizing apparatus may be textured for maximal comfort. The grip may also be a handle, strap loop or other attachment means that allows a user to hold the attachment means for stabilization of the electronic device during its use. Furthermore, the stabilizing apparatus may have a grip that is interchangeable and can be personalized with custom graphics, such as graphics of a users favorite sports team or action hero. Also, the grip may be connected to the hand-held electronic device through any connection mechanism, such as an extension arm, a snap-on clamp, and a strap. Additionally the stabilizing apparatus may be an extensible articulated shaft comprised of a plurality of segments connected by hinges or other suitable connecting means, which can bend and lock in to different shapes. Accordingly, other implementations are within the scope of the following claims.

What is claimed is:

1. An apparatus for stabilizing a hand-held electronic device during use of the hand-held electronic device, the apparatus comprising:
a grip configured to be held by a human hand; and
a connection mechanism to couple the grip to the hand-held electronic device.

2. The apparatus of claim 1, wherein the connection mechanism to couple the grip to the hand-held electronic device comprises an extension arm having a first end coupled to the grip and a second end coupled to the hand-held electronic device.

3. The apparatus of claim 2, wherein the extension arm is operable to extend or rotate the grip to an ergonomic position so that a thumb or a finger of the human hand is kinematically suited to access a plurality of input elements on one or more surfaces of the hand-held electronic device.

4. The apparatus of claim 2, wherein the extension arm is configured to be retracted or extended in a direction along or parallel to a lateral or longitudinal axis of the hand-held electronic device.

5. The apparatus of claim 2, wherein the extension arm is configured to be folded for storage in the hand-held electronic device.

6. The apparatus of claim 2, wherein the extension arm is configured to be rotated about a pivot coupled to the second end of the extension arm.

7. The apparatus of claim 2, wherein the extension arm comprises an articulating member having a plurality of independently moveable segments.

8. The apparatus of claim 3 further comprises a locking mechanism coupled to the extension arm, the locking mechanism operable to lock the extension arm in place.

9. An attachment for providing stability and comfort during data input or control of a hand-held electronic device, the attachment comprising:
a grip configured to be held by a human hand;
an extension arm having a first end coupled to the grip and a second end coupled to the hand-held electronic device; and
a locking mechanism coupled to the extension arm, the locking mechanism operable to lock the extension arm in place.

10. The attachment of claim 9, wherein the extension arm is configured to be extended or rotated to a position from the hand-held electronic device so as to optimize a biomechanical effectiveness of the human hand.

11. The attachment of claim 10, wherein to optimize the biomechanical effectiveness of the human hand results in a thumb or a finger of the human hand to be kinematically suited to access a plurality of input elements on one or more surfaces of the hand-held electronic device.

12. The apparatus of claim 10, wherein the extension arm comprises an articulating member having a plurality of independently moveable segments.

13. The apparatus of claim 12, wherein each of the independently moveable segments configured to be locked in place by the locking mechanism.

14. A hand-held electronic device comprising:
a first shell having a plurality of input elements disposed on one or more surfaces; and
a stabilizer configured for a human hand and coupled to the first shell, the stabilizer being operable to be in an ergonomic position so that a thumb or a finger of the human hand is kinematically suited to access a plurality of input elements on one or more surfaces of the hand-held electronic device.

15. The hand-held electronic device of claim 14 further comprising a locking mechanism coupled to the stabilizer, the locking mechanism operable to lock the stabilizer in place.

16. The hand-held electronic device of claim 15, wherein the stabilizer comprises:
a connection mechanism coupled to the first shell; and
a grip configured for the human hand.

17. The hand-held electronic device of claim 16, wherein the connection mechanism is configured to be retracted or extended in the direction of the lateral or longitudinal axis of the first shell.

18. The hand-held electronic device of claim 16, wherein the connection mechanism is configured to be folded for storage in the first shell.

19. The hand-held electronic device of claim 16, wherein the connection mechanism is configured to be rotated about a pivot coupled to the extension arm.

20. The hand-held electronic device of claim 16, wherein the connection mechanism comprises an articulating member having a plurality of independently moveable segments.

21. The hand-held electronic device of claim 16 further comprising a second shell having a display on a front surface and an end pivotally engaged with an end of the first shell.
